(19) United States
(12) Patent Application Publication
(10) Pub. No.: US 2023/0355463 A1
(43) Pub. Date: Nov. 9, 2023

(54) Stimulation Device

(71) Applicant: IOBA LLC, Boulder, CA (US)

(72) Inventor: Martin Cirillo-Schmidt, Dresden (DE)

(21) Appl. No.: 17/756,087

(22) PCT Filed: Nov. 17, 2020
(86) PCT No.: PCT/EP2020/082427

§ 371 Date: Jul. 20, 2022

(30) Foreign Application Priority Data
Nov. 18, 2019 (DE) 10 2019 131 062.8

(51) Int. Cl. A61H 19/00; A61H 23/02

(52) U.S. Cl. CPC A61H 19/44; A61H 23/0254; A61H 2201/0188; A61H 2201/1215; A61H 2201/1481; A61H 2201/1673; A61H 2201/1695; A61H 2201/5058

(57) ABSTRACT

The invention relates to a stimulation device comprising a main part and a rubber-elastic sleeve which is intended for contact with a body part of a user and which encloses the main part and has a reversibly deformable contact surface region, wherein a shaping element, which is designed to produce a locally limited deformation of the sleeve without deformation of the main part, is arranged on the main part so as to be movable relative to the main part, and an actuating device, which is operatively connected to the shaping element in order to generate a movement of the shaping element, is arranged on the main part and comprises an electric motor having a rotor shaft to which an eccentric is fastened, and the shaping element comprises a pivotally mounted lever having two free ends, wherein a first end of the lever is operatively connected to the eccentric of the actuating device in order to convert a rotation of the rotor shaft into a pivoting movement of the lever, and a second end of the lever acts in a deforming manner on the contact surface region.

The invention relates to a stimulation device with locally limited shape change, which can be used for example as a sexual or therapeutic aid, such as a massage device or an exercise device.

Massage devices usually serve for the mechanical influencing of skin, connective tissue, and muscles by stretching, pulling and pushing stimuli. The massage action extends from the site being treated on the body over the entire organism and also includes the psyche.

Massage devices which change their external shape are known in practice. Thus, there are massage devices which can be pneumatically inflated and thus change their volume and also their shape. Massage devices are also known which can increase their body volume by means of a mechanical rotation or shifting technique.

A vibrator having a housing and a silicone sleeve connected to the housing, as well as a vibration-generating electric motor, is known from DE 10 2012 109 409 A1.

Furthermore, a dildo is known from DE 10 2006 005 358 A1, the dildo body of which consists of a cylindrical piece and a front end, and comprises electrical heating means and connection elements for connection to a power source, the heating means being a heating foil arranged in tubelike manner in the cylindrical piece.

According to US 6,599,236 B1, a dildo comprises a heating coil as the heating element, which can be regulated by a thermostat in order to adjust the dildo to a desired temperature.

Such massage devices or dildos often consist of a rubber-elastic material or have a sleeve made from a rubber-elastic material.

According to DE 10 2012 019 842 A1, a massage device is known having at least one rubber-elastically deformable wall, having at least one actuator, which is arranged in order to act on a partial region of the elastic deformable wall, deforming it, wherein the actuator is formed with an electroactive polymer and the actuator is electrically connected to a control unit arranged in or directly on the massage device and can be actuated by means of this control unit.

The massage function here is produced by a deformation element inside a rubber-elastic outer wall, which deforms the outer wall outwardly in partial regions. A continuous force action is required for this, which besides the friction effects likewise occurring on the inside of the device results in a very large energy consumption.

From WO 2016/038028 Al there is known a stimulation device, which comprises a main part and a rubber-elastic sleeve, attached on or in the main part and intended for contact with a body part of a user, having at least one reversibly deformable contact surface region, wherein at least one shaping element which is designed to produce a local deformation of the sleeve without deformation of the main part is arranged on or in the main part so as to be movable relative to the main part, and at least one actuating device which is operatively connected to the shaping element in order to generate a movement of the at least one shaping element is arranged on or in the main part, comprising at least one shape memory element, which is deformable by applying an electric current and/or a magnetic field and/or by temperature change, and is connected on the one hand to the main part and on the other hand to the shaping element and causes a movement of the at least one shaping element by deformation.

It has been found that the use of a shape memory element as the drive for such a stimulation device is subject to very large technological requirements.

The problem which the present invention proposes to solve is to indicate a stimulation device which overcomes the drawbacks of known stimulation devices. This problem is solved by the invention as indicated in the claims. Advantageous embodiments are the subject matter of the dependent claims.

In order to solve the problem, a stimulation device is proposed, which comprises a main part and a rubber-elastic sleeve which is intended for contact with a body part of a user and which encloses the main part and has at least one reversibly deformable contact surface region, wherein at least one shaping element which is designed to produce a locally limited deformation of the sleeve without deformation of the main part is arranged on or in the main part so as to be movable relative to the main part, and at least one actuating device which is operatively connected to the at least one shaping element in order to generate a movement of the at least one shaping element is arranged on or in the main part, wherein the actuating device comprises an electric motor having a rotor shaft, on which an eccentric is fastened, the shaping element comprises a pivotably mounted lever having two free ends, wherein a first end of the lever is operatively connected to the eccentric of the actuating device in order to convert a rotating movement of the rotor shaft into a pivoting movement of the lever and a second end of the lever acts in a deforming manner on the contact surface region.

The proposed stimulation device in the specific instance can be configured as, for example, a vibrator, dildo, penis ring, masturbator, artificial vagina, anal plug, penis cuff, love balls, stretch tube, or the like. The stimulation device is advantageously suitable for use as a sexual or therapeutic aid for the stimulation of erogenous zones and/or muscles, such as the vaginal and anal muscles.

An outer surface of the stimulation device, i.e., one accessible to the user, is formed by a rubber-elastic sleeve intended for contact with a body part of the user, forming either the entire surface of the stimulation device or the greater portion of the surface of the stimulation device or only a relatively small portion of the surface of the stimulation device. This sleeve comprises at least one partial region which is reversibly deformable, which is called in the following the contact surface region. The sleeve, for example, can be made from rubber-elastic material such as silicone, latex, thermoplastic elastomers or the like. The sleeve can be attached to the main part such that the surface of the stimulation device accessible to the user is formed partially by the main part and partially by the sleeve. However, the sleeve can also enclose the main part entirely or for the most part.

A stimulation action is achieved in that a shaping element on the inner side of the sleeve, facing away from the user, is arranged so as to be movable and such that a movement of the shaping element produces a local deformation of the sleeve, more precisely, of the reversibly deformable contact surface region. The shaping element comprises a pivotably mounted lever having two free ends, i.e., the lever is hinged in its middle region, i.e., between the two free ends, so that a pivoting movement transmitted to one free end forcibly causes an equally directed pivoting movement of the other free end of the lever. The pivoting movement is generated in that a first free end of the lever is operatively connected to the eccentric of the actuating device in order to convert a rotating movement of the rotor shaft into a pivoting movement of the lever. The second free end of the lever, opposite the first free end, then acts in a deforming manner on the contact surface region of the rubber-elastic sleeve, so that the outer contour of the stimulation device is locally deformed to a limited extent, i.e., the rest of the surface of the stimulation device remains nondeformed. In order to make it possible for the second free end of the lever to act on the sleeve, the main part has an opening in the region of the deformable contact surface region.

The actuating device, which generates a pivoting movement of the lever and thus the local deformation of the stimulation device, comprises an electric motor having a rotor shaft, on which an eccentric is mounted, which acts on the first free end of the lever. Thanks to the eccentric, the rotating movement of the rotor shaft of the electric motor is converted into a pivoting movement of the lever.

The proposed stimulation device makes possible a very locally limited, pointlike stimulation. Thanks to appropriate actuation of the electric motor, a very low-frequency stimulation is possible, as shall be further explained below with the aid of advantageous embodiments of the proposed stimulation device.

According to a first embodiment of the stimulation device, the deformable contact surface region is formed by a protuberance of the rubber-elastic sleeve, which is connected to the second end of the lever. Thanks to the connection between the second free end of the lever and the sleeve, the local deformation of the sleeve in the reversibly deformable contact surface region is very exactly defined. Furthermore, in one specific configuration it can be provided that the second end of the lever comprises a thickening, the protuberance of the rubber-elastic sleeve comprises an indentation with undercutting, and the thickening is inserted into the indentation, engaging with the undercutting. Thanks to this configuration, on the one hand a three-dimensional stimulation element is formed by the protuberance, which stimulation element can be moved from a retracted position to an extended position and back by the pivoting movement of the lever, in order to achieve the greatest possible intensity of the stimulation, and on the other hand a force transfer from the lever to the deformable contact surface region is made possible not only during its outward movement, but also during its inward movement, i.e., bidirectionally.

In order to have a simultaneously simple and low-maintenance design, i.e., a reliable design for the converting of the rotating movement of the rotor shaft of the electric motor into a pivoting movement of the lever, it is provided in another embodiment that the first end of the lever in the proposed stimulation device comprises at least one sliding surface oriented transversely to a pivoting direction of the lever, with which the eccentric of the actuating device interacts in order to convert a rotating movement of the rotor shaft into a pivoting movement. Specifically, in one advantageous embodiment, it can be provided that the first end of the lever comprises a groove oriented transversely to a pivoting direction of the lever, the two groove flanks of which each form a sliding surface, and the eccentric of the actuating device comprises a pin, which protrudes into the groove, between the groove flanks.

The pin of the eccentric is arranged eccentrically relative to the axis of rotation of the electric motor, so that it describes a circular orbit. In this way, the movement component of this circular motion running in the pivoting direction of the lever is transformed into a pivoting movement of the lever, while the pin moves back and forth in the groove, transversely to the pivoting direction of the lever. For the best possible minimization of friction between pin and lever, it can be provided that the pin has a convex thickening, making contact with the groove flanks. A convex, for example a spherical thickening ensures that the contact surface between pin and lever is only pointlike, so that friction losses and wear and tear are extremely low.

Unlike what occurs in traditional vibrators, the proposed stimulation device should be capable of a very low-frequency stimulation, coming much closer to a manual stimulation than the otherwise typical high-frequency stimulation, which is based on unbalance of a rapidly moving electric motor. In order to accomplish this, it is provided in another embodiment that a control device having an operator element for influencing the speed of revolution of the electric motor is arranged on or in the main part. The control device for example can be an electronic circuit actuating the electric motor, which can be operated by an operator element such as a micro-key button or the like, so that the device can be switched on and off, and also one of multiple available speeds of revolution of the electric motor can be selected, resulting in a corresponding frequency of the stimulation. For example, the control device can be designed to actuate the electric motor with a speed of revolution of 5 rps or less, preferably 3 rps or less, especially 1 rps or less.

Known stimulation devices vibrate with frequencies which are a multiple higher than these values. The stimulation effect of such stimulation is based on stimulation, by high-frequency solid movement of the device, of points of the body that come into contact with it. It has been shown that a stimulation based on a periodic, low-frequency, pointlike application of force to treated points of the body accomplishes a much more pleasant and intensive stimulating action. This kind of stimulation at the indicated frequencies has been found to be especially pleasant, as is the pointlike action on treated points of the body of the user.

For example, a direct influencing of the frequency by the user can be made possible. For this, a key for example can be provided for switching the stimulation device on and off and for setting the frequency, and the frequency can either be raised or lowered continuously as long as the particular key is actuated, or the frequency can be raised or lowered in steps each time the particular key is pressed. Likewise, a pair of keys can be provided for setting the frequency, one of them producing a raising and the other a lowering of the frequency.

In other configurations, an indirect influencing of the frequency by the user can be made possible. For this, the stimulation device can have stimulation programs saved in the control device, for example, which generate different frequencies, while the frequency may be varied during the time of a program. The programs can also alternatively be saved in an app executed on a mobile terminal device. Such an app can be designed at the same time as a remote control for the stimulation device.

In one advantageous embodiment, for example, the control device can be designed to actuate the electric motor to create an oscillatory rotating movement (pendulum movement), during which the electric motor moves in an alternating manner in one direction of rotation and then in the other direction of rotation, each partial movement constituting less than one full revolution. In this way, it is possible to make the intensity of the massage adjustable, so that the previous limitation on setting the stroke with purely rotational drive units is resolved. In order to prevent premature wearing of the bearings, such stimulation programs can additionally contain programmed patterns which combine the pendulum movement with occasional 360° rotations, at the same time allowing a further improved stimulation with varying-stroke patterns.

The saved stimulation programs can likewise be called up as above by an operator element, for example, for the user’s selection of frequency and/or amplitude. For this, according to one embodiment, an individual key may be provided, for example, which when first pressed turns on the stimulation device and calls up a first stored stimulation program. If the key is pressed again, the next stored stimulation program is called up, and so on, until all stored stimulation programs have been selected one time. If the key is then pressed once again, this produces a shutoff of the stimulation device. According to another embodiment, one key serves for the on/off switching and another key for the program selection. Alternatively, a pair of keys can be provided for the program selection, one of them calling up the stored programs in ascending sequence and the other calling up the stored programs in descending sequence.

Of course, instead of keys other operator elements can likewise be used, such as toggle switches, knobs, and the like. One special advantage of keys is that they can be arranged in a simple water-tight manner underneath or behind a rubber-elastic sleeve, because they can still be operated with no problems due to the elastic quality of the sleeve.

However, such solutions are also encompassed in which the operator element or elements are part of a remote control, so that no operator elements need to be arranged on the stimulation device itself. If the remote control is an app executed on a mobile terminal device, the operator elements can be designed in the typical form for apps, for example, as buttons, sliders or the like which can be touch-operated on the screen of the mobile terminal device, and whose functions may correspond to those of the keys described above.

Especially advantageously, it can be provided that the electric motor is a step motor and the control device comprises a driver circuit for quasi-continuous driving of the step motor. Only with step motors is the desired low-frequency stimulation possible without the intervention of a transmission, further increasing the costs and being prone to faults, i.e., a direct drive. However, unless further measures are taken, step motors cause a characteristic, very annoying noise in the field of application of the invention. For this reason, a control device should have a driver circuit for quasi-continuous driving of the step motor, so that the step motor can be operated noiselessly.

In order to enhance the value of the stimulation device, but also to make it easier to turn it on and off, the control device for actuating the electric motor is designed in one especially advantageous modification such that the shaping element is always in the same position when the actuating device is switched off. Preferably, in this way the electric motor is halted so that the lever and thus the deformable contact surface region dwell in the retracted position. Specifically, it can be provided for this that the eccentric carries a permanent magnet and a Hall sensor is arranged in the main part in direct proximity to the eccentric and it is connected to the control device. In this way, the control device can switch off the motor exactly when the permanent magnet is located opposite the Hall sensor. Alternatively, this switching function can also be integrated in the Hall sensor.

According to another embodiment it can be provided that at least one energy accumulator for the storing of electric energy is arranged at or in the main part. Although it is also possible to supply the electric energy needed to operate the stimulation device from the outside, for example by connecting the stimulation device to a power cable, it is advantageous for an easy handling of the stimulation device that it be cordless. This can be achieved by arranging an energy accumulator directly on or in the stimulation device.

In one embodiment it is provided that the energy accumulator comprises at least one rechargeable storage battery. This avoids the need for the user to have to open the stimulation device to replace non-rechargeable batteries once they are depleted.

Advantageously, it can furthermore be provided that at least one receiving coil for the noncontact supply of electric energy is arranged at or in the main part. In this way, for example, a storage battery arranged in the stimulation device can be charged in a noncontact manner. Thus, no metallic contacts are required on the outside of the stimulation device, so that the stimulation device is even safer in its handling and can be easily made in a water-tight design.

Further advantageously, the control device can comprise a light source, such as one or more LEDs, which indicate to the user of the stimulation device whether the device is switched on and/or which program has been selected and/or what state of charge the energy accumulator has and/or whether a charging process is taking place and/or making possible a desired lighting of certain regions of the stimulation device. For this, it can moreover be provided advantageously that the main part or a housing piece of the stimulation device has at least one fiber optic element. Such a fiber optic element may be, for example, a transparent glass or plastic fiber, which guides the light from the light source to an area needing to be illuminated of the stimulation device and delivers the light there. But such a fiber optic element can also comprise, for example, a transparent insertion in a housing piece of the main part, which guides the light generated by an LED through the housing to the outside, for example, a spot of light in the vicinity of the operator element, a luminous ring around the operator element, and so forth, the light being strong enough to pass through the rubber-elastic sleeve to the outside and to be perceived.

Exemplary embodiments of the proposed stimulation devices will be explained more closely below with the aid of drawings. In the figures:

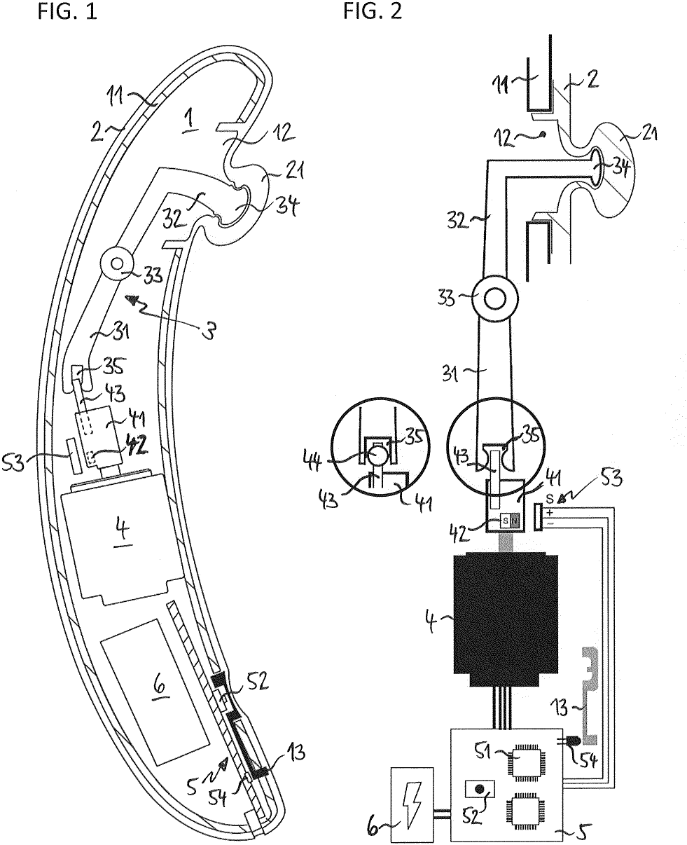

FIG. 1 shows a longitudinal section through a stimulation device according to an exemplary embodiment,

FIG. 2 shows a functional diagram of the stimulation device according to the exemplary embodiment,

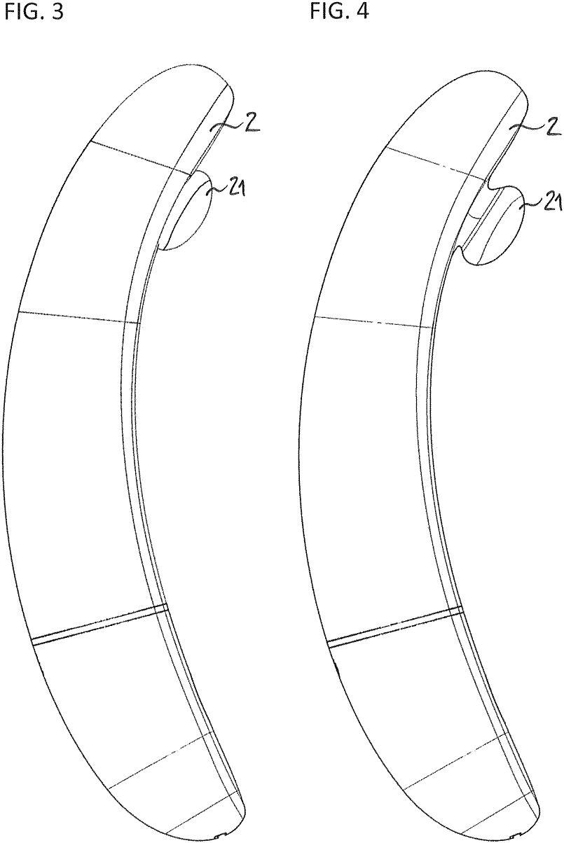

FIG. 3 shows a front view of the stimulation device, in which the contact surface element is in the retracted position, and

FIG. 4 shows a front view of the stimulation device, in which the contact surface element is in the retracted position.

FIG. 1 shows in a schematic front view a longitudinal section through an exemplary stimulation device. A rubber-elastic sleeve 2 of silicone encloses a main part 1 formed from two housing pieces 11. On the main part 1 a shaping element 3 is arranged in a movable manner, having a first free end 31 and a second free end 32 and arranged movably between the first free end 31 and the second free end 32 by a joint 33 on the main part 1. The housing pieces 11 together define the basic shape of the stimulation device, being bounded on the outside by the rubber-elastic sleeve 2.

On the inside of the stimulation device there is arranged the actuating device, comprising an electric motor 4 having a rotor shaft, on which an eccentric 41 is fastened. The electric motor 4 in the exemplary embodiment is designed as a step motor.

The shaping element, as already described, is a pivotably mounted lever 3 with two free ends 31 and 32. The first end 31 of the lever 3 is operatively connected to the eccentric 41 and the second end 32 of the lever 3 acts in a deforming manner on the contact surface region 21. The deformable contact surface region 21 is formed by a protuberance of the rubber-elastic sleeve 2, having an indentation with undercutting. The second end 32 of the lever 3 has a thickening 34, which is inserted into the indentation, engaging with the undercutting. This configuration is especially advantageous for an easy cleaning of the stimulation device. The thickening 34 of the lever 3 can be easily pulled out from the undercutting of the indentation of the rubber-elastic sleeve 2, in order to clean the rubber-elastic sleeve 2 easily under running water. The thickening 34 can then be easily snapped back into the indentation.

The first end 31 of the lever 3 comprises a groove 35 oriented transversely to the pivoting direction of the lever 3, the two groove flanks of which each form a sliding surface, and the eccentric 41 of the actuating device comprises a pin 43, which protrudes into the groove 35.

FIG. 2 shows two variants of the interacting elements of the first free end 31 of the lever 3 and the pin 43 of the eccentric 41: in the detail view on the left, the pin 43 has a convex thickening 44, which makes contact with the groove flanks. In the representation on the right, the pin 43 has no such thickening; instead, however, the two groove flanks of the groove 35 in the first free end 31 of the lever 3 are convex, so that in both variants the contact surface between pin 43 and groove 35 is the smallest possible.

In the main part 1 there is arranged a control device 5 having an operator element 52 for influencing the speed of revolution of the electric motor 4. The control device 5 comprises an electronic circuit, having a driver circuit 51 for quasi-continuous driving of the step motor 4, a micro-key button 52 for operating the stimulation device, which can be operated through the rubber-elastic sleeve 2, and a light source in the form of an LED, which indicates the state of the stimulation device. In order to make the light produced by the LED visible on the outside, the housing piece 11 on top of the light source 54 has a fiber optic element 13, which is designed as an inclusion of transparent plastic in the otherwise non-transparent housing piece 11 of the main part 1. The light is strong enough to pass through the rubber-elastic sleeve 2.

The control device 5 is connected to an energy accumulator 6, which in the exemplary embodiment is designed as a rechargeable storage battery. The control device 5 is furthermore connected to the step motor 4 in order to supply it with energy.

Furthermore, the control device 5 is designed to actuate the electric motor 4 such that the lever 3 is always in the same position when the actuating device is switched off. The eccentric 41 carries a permanent magnet 42 and a Hall sensor 53 with switching function is arranged in the main part 1 in direct proximity to the eccentric 41 and it is connected to the control device 5.

Stimulation device List of reference numbers

| | |
|---|---|
| 1 | Main part |
| 11 | Housing piece |
| 12 | Opening |
| 13 | Fiber optic element |
| 2 | Rubber-elastic sleeve |
| 21 | Deformable contact surface region |
| 3 | Lever |
| 31 | First free end |
| 32 | Second free end |
| 33 | Joint |
| 34 | Thickening |
| 35 | Groove |
| 4 | Electric motor |
| 41 | Eccentric |
| 42 | Permanent magnet |
| 43 | Pin |
| 44 | Thickening |
| 5 | Control device |
| 51 | Driver circuit |
| 52 | Operator element |
| 53 | Hall sensor |
| 54 | Light source |
| 6 | Energy accumulator |

1. A stimulation device, comprising
a main part and
a rubber-elastic sleeve which is intended for contact with a body part of a user and which encloses the main part and has at least one reversibly deformable contact surface region, wherein
at least one shaping element which is designed to produce a locally limited deformation of the sleeve without deformation of the main part is arranged on or in the main part so as to be movable relative to the main part, and
at least one actuating device which is operatively connected to the at least one shaping element in order to generate a movement of the at least one shaping element is arranged on or in the main part, the actuating device including an electric motor having a rotor shaft, on which an eccentric is fastened
the shaping element including a pivotably mounted lever having two free ends, wherein
a first end of the lever is operatively connected to the eccentric of the actuating device in order to convert a rotating movement of the rotor shaft into a pivoting movement of the lever and
a second end of the lever acts in a deforming manner on the contact surface region.

2. The stimulation device as claimed in claim 1, wherein the deformable contact surface region is formed by a protuberance of the rubber-elastic sleeve, which is connected to the second end of the lever.

3. The stimulation device as claimed in claim 2, wherein the second end of the lever comprises a thickening, the protuberance of the rubber-elastic sleeve comprises an indentation with undercutting, and the thickening is inserted into the indentation, engaging with the undercutting.

4. The stimulation device as claimed in claim 1, wherein the first end of the lever comprises at least one sliding surface oriented transversely to a pivoting direction of the lever, with which the eccentric of the actuating device interacts in order to convert a rotating movement of the rotor shaft into a pivoting movement of the lever.

5. The stimulation device as claimed in claim 4, wherein the first end of the lever comprises a groove oriented transversely to a pivoting direction of the lever, the two groove flanks of which each form a sliding surface, and the eccentric of the actuating device comprises a pin, which protrudes into the groove, between the groove flanks.

6. The stimulation device as claimed in claim 5, wherein the pin has a convex thickening, making contact with the groove flanks.

7. The stimulation device as claimed in claim 1, wherein a control device having an operator element for influencing the speed of revolution of the electric motor is arranged on or in the main part.

8. The stimulation device as claimed in claim 7, wherein the control device is designed to actuate the electric motor with a speed of revolution of 5 rps or less.

9. The stimulation device as claimed in claim 7, wherein the electric motor is a step motor and the control device comprises a driver circuit for quasi-continuous driving of the step motor.

10. The stimulation device as claimed in claim 7, wherein the control device is designed to actuate the electric motor to create an oscillatory rotating movement (pendulum movement), during which the electric motor moves in an alternating manner in one direction of rotation and then in the other direction of rotation.

11. The stimulation device as claimed in claim 7, wherein the control device is designed to actuate the electric motor such that the shaping element is always in the same position when the actuating device is switched off.

12. The stimulation device as claimed in claim 11, wherein the eccentric carries a permanent magnet and a Hall sensor is arranged in the main part in direct proximity to the eccentric and it is connected to the control device.

13. The stimulation device as claimed in claim 1, wherein the control device comprises at least one light source and the main part or a housing piece of the main part comprises at least one fiber optic element.

14. The stimulation device as claimed in claim 1, wherein at least one energy accumulator for the storing of electric energy is arranged at the main part.

15. The stimulation device as claimed in claim 14, wherein the energy accumulator comprises at least one rechargeable storage battery.

16. The stimulation device as claimed in one of claim 1, wherein at least one receiving coil for a noncontact supply of electric energy is arranged at or in the main part.

17. The stimulation device as claimed in claim 7, wherein the control device is designed to actuate the electric motor with a speed of revolution of 3 rps or less.

18. The stimulation device as claimed in claim 7, wherein the control device is designed to actuate the electric motor with a speed of revolution of 1 rps or less.
